(19) United States
(12) Patent Application Publication
(10) Pub. No.: US 2013/0000735 A1
(43) Pub. Date: Jan. 3, 2013

(54) PRESSURE RELIEF APPARATUS FOR HYDROPNEUMATIC VESSEL

(76) Inventors: Martin J. Blaze, Hamden, CT (US); Hemang R. Patel, Middletown, CT (US); Neal M. Duval, Manchester, CT (US)

(21) Appl. No.: 13/634,566

(22) PCT Filed: Mar. 18, 2011
(86) PCT No.: PCT/US11/28999

§ 371 Date: Sep. 13, 2012

Related U.S. Application Data
(60) Provisional application No. 61/315,678, filed on Mar. 19, 2010.

(51) Int. Cl. B65D 25/04; F16K 15/00

(52) U.S. Cl. 137/1; 220/530

(57) ABSTRACT

An accumulator with a bladder or a diaphragm separating a gas chamber from an incompressible liquid chamber, the accumulator having a pressure relief valve to release gas from the gas chamber in case of overpressure; a device for filling and releasing the gas from the gas chamber.

### BACKGROUND

Incompressible fluids such as water or other liquids are often supplied for use in residential and commercial applications. Often, such fluids are supplied by a pump or other motive force to an outlet such as a faucet for consumption by a user or a machine. The user or machine often demands that the fluid be supplied at a relatively high, sustained flow rate to ensure that the fluid is delivered in a timely manner for the given end use. For example, a user may want to quickly fill several containers with drinking water. As another example, a commercial coffee machine may require relatively large volumes of water in a short time span to fill carafes with hot coffee for customers during periods of high demand. In such applications, a stable water flow rate may be desirable to achieve consistent brewing such that the coffee tastes the same from batch to batch.

Typically, a pump alone is insufficient to meet the above requirements of sustained high flow rate. A typical pump supplies pressure and flow only when it is running Thus, a typical pump would need to be running at all times when fluid was demanded by the downstream user or machine. However, such demand is often frequent and intermittent, such that a pump may be forced to cycle on and off rapidly, likely leading to inefficient use of electricity and possibly premature pump failure. Moreover, because a pump in such a configuration would typically rely upon a drop in pressure to switch into service, the end user or machine would likely see undesirable fluctuations in flow rate.

To mitigate the above problems, a hydropneumatic tank may be installed in the incompressible fluid line downstream of the pump, but upstream of the faucet or other outlet. One type of hydropneumatic tank includes an internal flexible barrier that separates the incompressible fluid from a compressible fluid. In such hydropneumatic tanks, one side of the flexible barrier is typically pre-charged with a fixed amount of compressible fluid—often air or nitrogen—providing a cushion against which the pumped incompressible fluid may push. Increasing the volume and pressure of incompressible fluid in the hydropneumatic tank causes corresponding expansion or contraction of the flexible barrier such that the pre-charged compressible fluid is compressed. Such compression of the compressible fluid stores potential energy that can be later used to force the incompressible fluid from the hydropneumatic tank to the outlet. Because the incompressible fluid is driven to the outlet by the potential energy stored in the compressible fluid, the pump need not run continuously to provide a sustained fluid flow. Rather, the pump need only switch on occasionally to maintain the pressure in the hydropneumatic tank at acceptable levels.

In practice, certain malfunctions may cause the pressure of the incompressible fluid to exceed acceptable levels. For example, a pressure switch in the incompressible fluid stream may fail, causing incorrect feedback to the pump and allowing the pump to continue pressurizing the fluid above acceptable levels. In another example, unexpected thermal expansion of the incompressible fluid may cause a pressure condition that exceeds acceptable levels. In such cases, the hydropneumatic tank may be allowed to pressurize in an uncontrolled state. Uncontrolled over-pressurization can lead to system malfunction and structural tank failure

One solution to the above problem is providing a pressure relief valve in the incompressible fluid stream. Such a valve, when operational, can provide pressure regulation of the incompressible fluid by ejecting incompressible fluid from the system, thus ensuring that its pressure does not exceed safe and acceptable operating levels.

Unfortunately, provision of a pressure relief valve in the incompressible fluid stream may only hide the underlying problem, allowing it to persist undetected. For example, the fluid outlet of a pressure relief valve in the incompressible fluid stream is often plumbed directly to a drain, such that ejected fluid—which is often pressurized and/or hot—is safely routed down the drain and away from the end user or machine. Because of this automatic re-routing of ejected fluid, busy workers may not notice that over-pressure conditions are occurring. Unaware of the symptom, they are more likely to be unaware of the underlying condition that is causing the unwanted over-pressure.

Moreover, as over-pressure conditions are allowed to persist in the incompressible fluid stream, the pressure relief valve is allowed to actuate repeatedly, potentially causing wear that may eventually lead to failure. Even if wear does not cause failure, repeated actuation of the pressure relief valve in the liquid stream can result in dissolved solids or other contaminants present in the incompressible fluid interfering with proper operation of the valve. Over time, such contaminants may cause the pressure relief valve to foul, corrode, or seize, ultimately leading to failure of the valve.

In the event such a pressure-relief valve fails, the incompressible fluid stream may be allowed to pressurize unchecked, potentially leading to periodic or sustained unsafe pressures in the hydropneumatic tank.

There is a need for a system that can help mitigate unacceptable over-pressure conditions in a hydropneumatic tank. There is also a need for a system that can help mitigate unacceptable over-pressure conditions in a hydropneumatic tank while alerting end users and workers to the existence of underlying conditions that are causing over-pressurization. There is also a need for a system that can decrease the potential energy stored in a hydropneumatic tank such that the energy releasable in a failure of the tank is reduced.

### SUMMARY OF THE INVENTION

The present disclosure provides a hydropneumatic system that can release compressible fluid from a hydropneumatic vessel when overpressure conditions occur in a corresponding incompressible fluid. By releasing compressible fluid from the vessel, exemplary hydropneumatic systems according to the present disclosure can reduce the amount of compressible fluid available for compression, thus reducing the vessel's capacity for storing potential energy. Because exemplary hydropneumatic systems according to the present disclosure can reduce a vessel's capacity for storing potential energy, the overall flow performance benefit of the hydropneumatic system can be reduced and eventually eliminated over time, thus alerting end users to the existence of a condition causing unacceptable over-pressurization of the incompressible fluid. A further benefit of reducing a vessel's capacity for storing potential energy according to the present disclosure is reduction in the amount of energy releasable in the event the vessel structurally fails.

In one aspect, the present disclosure provides a hydropneumatic system comprising a fluid vessel comprising an incompressible fluid portion and a compressible fluid portion to contain a compressible fluid at a first pressure, the compressible fluid portion being in pressure communication with the incompressible fluid portion and separated from the incompressible fluid portion by a flexible barrier. Such embodiments further comprise an incompressible fluid source to supply an incompressible fluid at a second pressure to the incompressible fluid portion, the first pressure being in substantial equilibrium with the second pressure. Such embodiments further comprise an incompressible fluid outlet in fluid communication with the incompressible fluid portion and a pressure relief apparatus in fluid communication with the compressible fluid portion to release at least a portion of the compressible fluid from the fluid vessel when the first pressure exceeds a threshold pressure.

In some embodiments, the flexible barrier comprises an expandable bladder. In one embodiment, the flexible barrier comprises a diaphragm.

In one aspect, the incompressible fluid source comprises a filtration system. In such embodiments, the filtration system may comprise a reverse osmosis filtration element.

In one embodiment, the incompressible fluid source comprises a fluid pump. In such embodiments, the fluid pump may comprise a well pump.

In some embodiments, the hydropneumatic system further comprises a first compressible fluid charging port in fluid communication with the compressible fluid portion. In some such embodiments, the pressure relief apparatus is connected to the first compressible fluid charging port. In one embodiment, the pressure relief apparatus is threadably connected to the first compressible fluid charging port.

In some embodiments, the first compressible fluid charging port comprises a first spring-assisted poppet valve. In some such embodiments, the pressure relief apparatus comprises a valve-depressing member to depress the first spring-assisted poppet valve.

In one embodiment, the hydropneumatic system further comprises a second compressible fluid charging port in fluid communication with the compressible fluid portion and accessible while the pressure relief apparatus is connected to the first compressible fluid charging port.

In one aspect, the present disclosure provides a hydropneumatic system as described above wherein the incompressible fluid source comprises a pressure control device to control the second pressure to an operating pressure, wherein the operating pressure is lower than or equal to the threshold pressure.

The present disclosure further provides a method of limiting the potential energy stored in a fluid vessel comprising supplying an incompressible fluid at a second pressure to an incompressible fluid portion of the fluid vessel, the fluid vessel comprising a compressible fluid portion comprising a compressible fluid at a first pressure, the compressible fluid portion being in pressure communication with the incompressible fluid portion and separated from the incompressible fluid portion by a flexible barrier such that the first pressure is in substantial equilibrium with the second pressure, supplying the incompressible fluid to an incompressible fluid outlet, and releasing at least a portion of the compressible fluid from the fluid vessel when the first pressure exceeds a threshold pressure.

In one embodiment, the compressible fluid portion is separated from the incompressible fluid portion by an expandable bladder. In some embodiments, the compressible fluid portion is separated from the incompressible fluid portion by an elastomeric barrier.

In some embodiments, the method further comprises releasing a sufficient amount of the compressible fluid from the fluid vessel to cause the compressible fluid portion to cease assisting in the supply of incompressible fluid to the incompressible fluid outlet.

In one aspect, the method further comprises controlling the second pressure to an operating pressure, wherein the operating pressure is lower than or equal to the threshold pressure.

As used herein “incompressible fluid” includes fluids that are substantially incompressible, but allow for very slight compression in, for example, varying pressure or temperature conditions. For example, water is typically considered an “incompressible fluid,” even though it may be compressed to an extremely small extent in certain conditions.

These and other aspects of the invention will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1A is a schematic view of an exemplary hydropneumatic system according to the present disclosure wherein the fluid vessel contains a full charge of compressible fluid and a relatively small volume of incompressible fluid at a relatively low pressure;

FIG. 1B is a schematic view of an exemplary hydropneumatic system according to the present disclosure in a typical operating state wherein the compressible fluid in the fluid vessel is compressed to supply force to drive the incompressible fluid to the incompressible fluid outlet;

FIG. 1C is a schematic view of an exemplary hydropneumatic system according to the present disclosure wherein the pressure of the compressible fluid has exceeded a threshold pressure and compressible fluid is being released from the fluid vessel;

FIG. 1D is a schematic view of an exemplary hydropneumatic system according to the present disclosure wherein substantially all of the compressible fluid has been released from the fluid vessel;

FIG. 2A is a schematic view of an exemplary hydropneumatic system according to the present disclosure wherein the fluid vessel contains a full charge of compressible fluid and a relatively small volume of incompressible fluid at a relatively low pressure;

FIG. 2B is a schematic view of an exemplary hydropneumatic system according to the present disclosure in a typical operating state wherein the compressible fluid in the fluid vessel is compressed to supply force to drive the incompressible fluid to the incompressible fluid outlet;

FIG. 3 is a schematic view of an exemplary hydropneumatic system according to the present disclosure wherein the incompressible fluid source comprises a filtration system;

FIG. 4 is a schematic view of an exemplary hydropneumatic system according to the present disclosure wherein the incompressible fluid source comprises a fluid pump;

FIG. 5 is a partial detailed schematic view of an exemplary hydropneumatic system according to the present disclosure wherein the fluid vessel comprises a first compressible fluid charging port and a pressure relief apparatus;

FIG. 6 is a partial detailed schematic view of an exemplary hydropneumatic system according to the present disclosure wherein the fluid vessel comprises a first compressible fluid charging port and a pressure relief apparatus connected to the first compressible fluid charging port; and

FIG. 7 is a partial detailed schematic view of an exemplary hydropneumatic system according to the present disclosure wherein the fluid vessel comprises a first compressible fluid charging port and a pressure relief apparatus and second compressible fluid charging port connected to the first compressible fluid charging port.

### DETAILED DESCRIPTION OF THE DRAWINGS

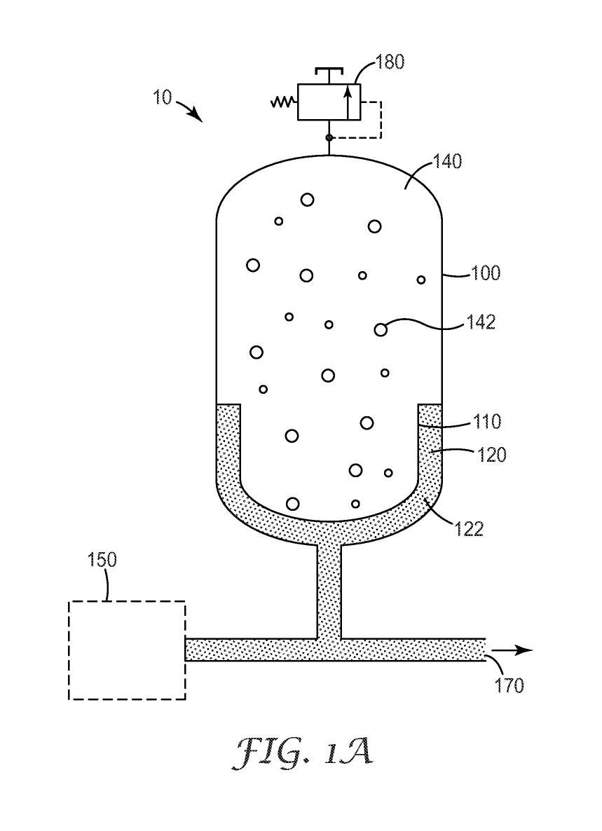

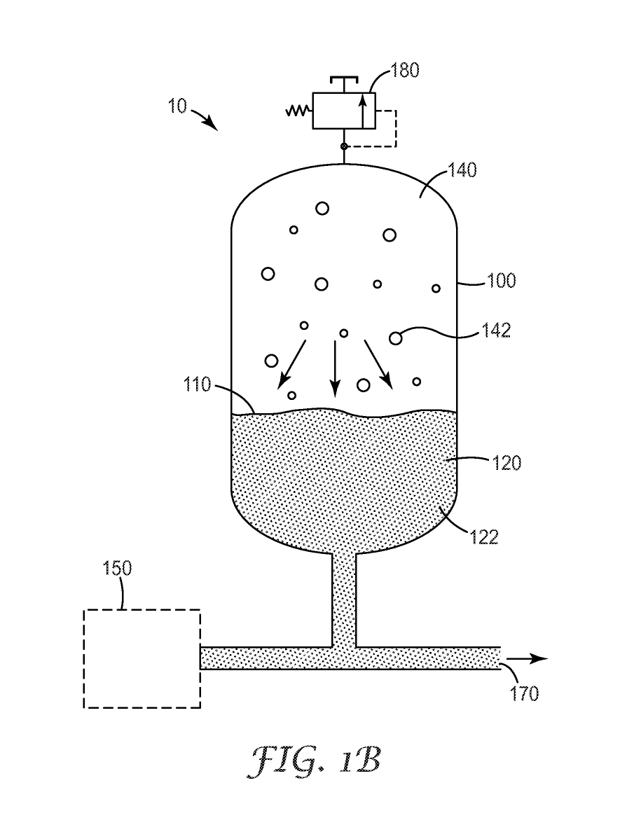

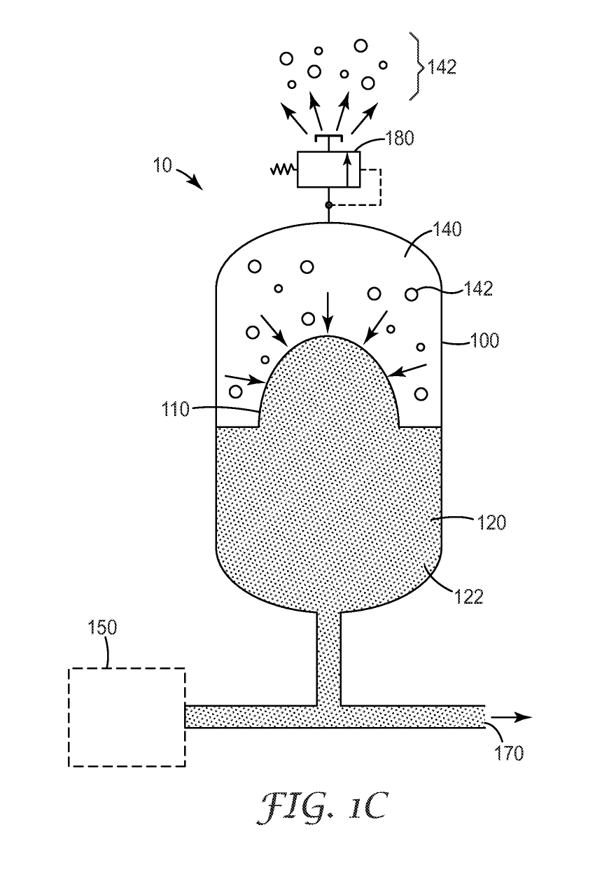

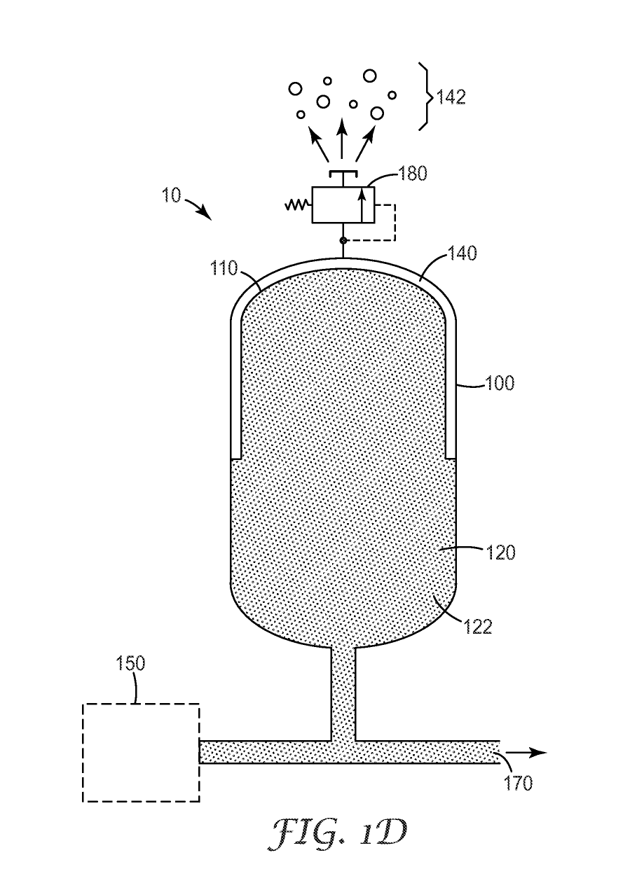

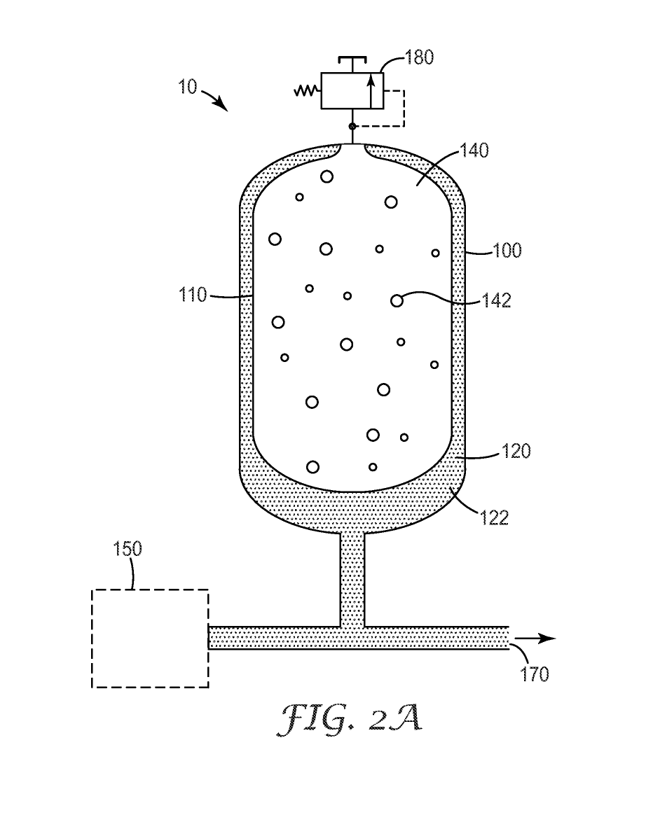

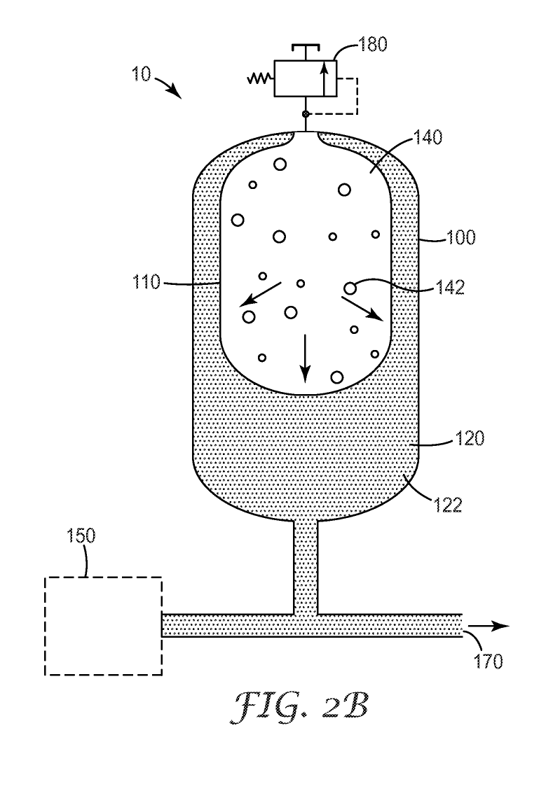

FIG. 1A is a schematic view of an exemplary hydropneumatic system 10 according to the present disclosure. As shown, a fluid vessel 100 is internally separated into a compressible fluid portion 140 and an incompressible fluid portion 120. The compressible and incompressible fluid 122 portions are separated by a flexible barrier 110. The flexible barrier 110 may comprise, for example, an expandable bladder, as depicted in FIGS. 2A and 22B, or may be a diaphragm as shown in FIGS. 1A-1D. Typically, the flexible barrier 110 is constructed of a material that is impervious to either fluid such that there is no fluid communication between the compressible fluid portion 140 and the incompressible fluid portion 120. It is to be understood, however, that a certain level of insubstantial fluid communication across the flexible barrier 110, such as by slow diffusion of a compressible gas through the flexible barrier 110 in the incompressible fluid 122, may not affect proper steady-state operation of the system and thus may be tolerated. Possible materials for the flexible barrier 110 include, for example, elastomers and composites of elastomers and other materials to alter strength, elasticity, or permeability.

As shown in FIG. 1A, the compressible fluid portion 140 is pre-charged with a fixed pressure of a compressible fluid 142 at a first pressure and the incompressible fluid portion 120 comprises an incompressible fluid 122 at a second pressure. Because the second pressure and the volume of the incompressible fluid 122 in the fluid vessel 100 are relatively low as shown in FIG. 1, and because the first pressure and second pressure are in substantial equilibrium, the compressible fluid 142 is minimally compressed. Because the first pressure is below a threshold pressure of the pressure relief apparatus 180, no compressible fluid 142 is released from the compressible fluid portion 140.

Referring now to FIG. 1B, more incompressible fluid 122 has been supplied from the incompressible fluid source 150 and not allowed to escape through the incompressible fluid outlet 170. As such, the second pressure is increased. The first pressure increases proportionally, thus compressing the fixed amount of compressible fluid 142 into a smaller volume. FIG. 1B thus depicts a typical operating condition for the hydroneumatic system wherein the compressible fluid portion 140 contains a compressible fluid 142 compressed to a sufficient extent that the compressible fluid portion 140 provides a cushion and force to drive incompressible fluid 122 from the incompressible fluid outlet 170 on demand. Again, the first pressure, though increased relative to the condition depicted in FIG. 1A, remains below the threshold pressure of the pressure relief apparatus 180, and no compressible fluid 142 is released from the compressible fluid portion 140.

Turning to FIG. 1C, an over-pressure condition originating in the incompressible fluid source 150 has caused the second pressure to further increase beyond the threshold pressure. Because the first pressure and second pressure are in substantial equilibrium, the first pressure is also increased beyond the threshold pressure. Thus, a portion of the compressible fluid 142 is released from the pressure relief apparatus 180 until the first pressure decreases to a level less than or equal to the threshold pressure. A portion of the compressible fluid 142 having been released, the hydropneumatic system 10 returns to a configuration substantially as shown in FIG. 1B, except that a lesser amount of compressible fluid 142 is now present in the compressible fluid portion 140. Because less incompressible fluid 122 is now present, the compressible fluid portion 140 is less capable of providing cushioning and force to the incompressible fluid 122, resulting in a net loss in capacity of the fluid vessel 100 to deliver sustained fluid flow to the incompressible fluid outlet 170.

Depending on the amount of compressible fluid 142 released during each over-pressure condition, a certain number of over-pressure events will cause the condition depicted in FIG. 1D, wherein substantially all of the compressible fluid 142 has been released from the fluid vessel 100. During a sustained over-pressure situation, this release may occur in one continuous event. With substantially all of the compressible fluid 142 released from the fluid vessel 100, the fluid vessel 100 ceases to provide cushion or driving force against the incompressible fluid 122. In practical effect, the condition depicted in FIG. 1D is no different than a situation where the fluid vessel 100 is entirely removed from the system. There being no cushion or driving force, the hydropneumatic system 10 loses the ability to assist in driving incompressible fluid 122 to the incompressible fluid outlet 170, thus leaving only the incompressible fluid source 150 to supply pressure and volume to the incompressible fluid outlet 170. As described above, this condition typically results in unacceptable system performance. If allowed to persist, this condition may eventually lead to pump failure, etc.

The provision of a pressure relief apparatus 180 on the compressible fluid portion 140 of the fluid vessel 100 allows for the progression depicted in FIGS. 1A-1D to occur. As flow performance at the incompressible fluid outlet 170 decreases, the end user is alerted to the occurrence of over-pressure conditions in the incompressible fluid 122 supply. This alerting function can allow an end user to contact an appropriate technician to investigate the source of such overpressure conditions so they can be fixed before damage to the system occurs.

A further benefit of allowing for the progression depicted in FIGS. 1A-1D to occur is the transition of the hydropneumatic system 10 to a more acceptable failure mode should unexpected structural failure of the fluid vessel 100 occur. For example, a fluid vessel 100 that has sustained damaged in the field may become structurally compromised. In its compromised state, the fluid vessel 100 may rupture at a pressure lower than its rated pressure. In the event such rupture occurs, any fluid contained within the fluid vessel 100 will be released to the atmosphere. If a substantial amount of highly-compressed compressible fluid 142 resides in the fluid vessel 100 at the time of rupture, such compressed fluid can explosively expand as the potential energy in the compressed fluid is rapidly released. Because hydropneumatic systems according to the present disclosure work to reduce the amount of compressible fluid 142 in the fluid vessel 100, leaving instead much lower potential energy incompressible fluid 122, the potential energy releasable upon such rupture can be at a substantially lower energy than previous systems.

The prophetic Example described below illustrates the above-described benefit with regard to a hypothetical fluid vessel 100.

### Prophetic Example

Assume a fluid vessel 100 as depicted in FIGS. 1A-12B and having a volume as shown in Table 1 below, except that no pressure relief apparatus 180 is provided. Further assume compressible and incompressible fluids having characteristics as described in Table 1 below:

TABLE 1

| | English/ | | | |
|---|---|---|---|---|
| | Common | | SI | |
| Description | Units | | Units | |
| Internal volume of fluid vessel (Vₒ) | 80 | gallons | 0.302 | m³ |
| Temperature of compressible fluid (air) (T) | 25° | C. | 298° | K |
| Temperature of incompressible fluid (water) (T) | 25° | C. | 298° | K |
| Atmospheric pressure (Pₒ) | 14.69 | psi | 101,325 | Pa |
| Typical absolute fluid pressure in fluid vessel | 90 | psi | 620,528 | Pa |
| Elevated absolute fluid pressure in fluid vessel | 200 | psi | 1,378,951 | Pa |

| | | | |
|---|---|---|---|
| Universal gas constant (air) (R) | — | 0.287 | kJ/(kg · ° K) |
| Density of compressible fluid (air) at 25° C. | — | 1.184 | kg/m³ |
| Mass of compressible fluid (air) in vessel (M_{AIR}) | — | 0.358554 | kg |
| Compressibility of water at 25° C. (γ) | — | 4.68 · 10⁻¹⁰ | Pa⁻¹ |

Next, assume a sufficiently expandable flexible barrier 110 such that the entire internal volume of the fluid vessel (presently free of any incompressible fluid) is initially pre-charged to atmospheric pressure with air as the compressible fluid. It should be understood that the foregoing assumption reflects an idealized state that, while not likely realizable in practice, is useful for illustrating the benefits of the present disclosure.

The fluid vessel is then connected to a hydropneumatic system 10 and an incompressible fluid (water) is introduced to the incompressible fluid portion 120 of the fluid vessel from an incompressible fluid source. The water is then allowed to pressurize to the typical absolute fluid pressure of 90 psi (620,528 Pa) from Table 1. Because the compressible fluid pressure and the incompressible fluid pressure will be in substantial equilibrium, the air pressure is thus also pressurized to 90 psi (620,528 Pa).

Due to pressurization of these fluids, they each now store some potential energy in their compressed state. Because the air is a compressible gas (and assuming isothermal compression and expansion with no losses), its available potential energy (in units of kJ) can be expressed as:

$${E}_{AIR} = R \cdot T [ ( \frac{{P}_{o}}{{P}_{1}} ) - 1 + ln ( \frac{{P}_{1}}{{P}_{o}} ) ] \cdot {M}_{AIR} , \qquad Eq . 1$$

where R, T, Pₒ, M_{AIR} and are found in Table 1 above and P₁ is the current fluid pressure—in this case 90 psi (620,528 Pa). Note that the mass of the air has not changed, since no air was released from the fluid vessel. However, the volume of the air has decreased due to compression. Using the Ideal Gas Law, the new volume of the air (V₁) may be calculated as:

$${V}_{1} = ( \frac{{P}_{o}}{{P}_{1}} ) \cdot {V}_{o} \qquad Eq . 2$$

Conversely, because the water is a substantially incompressible fluid, its available energy (also in units of kJ) can be expressed as:

$${E}_{WATER} = ( \frac{γ}{2} ) \cdot {V}_{WATER} \cdot {P}_{1}^{2} , \qquad Eq . 3$$

where γ is the compressibility of water from Table 1 above, V_{WATER} is the current volume of water in the fluid vessel, and P₁ is the current fluid pressure—in this case 90 psi (620,528 Pa). Because we know the new volume of air in the fluid vessel, V_{WATER} can be calculated as:

V_{WATER}=Vₒ−V₁ Eq. 4:

Plugging in the values from Table 1 gives the following results:

TABLE 2
Energy Stored in Hypothetical Fluid Vessel
at Typical Pressure

| | English/Common | SI |
|---|---|---|
| Description | Units | Units |
| Volume of Air (V₁) | 13.06 gallons | 0.049 m³ |
| Volume of Water (V_{WATER}) | 66.94 gallons | 0.253 m³ |
| Available energy of air (E_{AIR}) | — | 29.92 kJ |
| Available energy of water (E_{WATER}) | — | 0.016 kJ |
| Total available energy (E_{AIR} + E_{WATER}) | — | 29.94 kJ |

In a typical system, such internal pressures (90 psi (620,528 Pa)) are well within the safe operating range for the fluid vessel, and thus there is little risk of structural failure of the fluid vessel. Thus, there is little risk for release of the energy stored in the fluid vessel to atmosphere.

Next, consider the same fluid vessel where the internal pressure is increased to the elevated pressure of 200 psi (1,378,951 Pa) from Table 1. Assume further that the elevated pressure meets or exceeds the safe operating pressure of the fluid vessel. Plugging the elevated values into Eqs. 1-4 gives the following results:

TABLE 3
Energy Stored in Hypothetical Fluid Vessel
at Elevated Pressure

| | English/Common | SI |
|---|---|---|
| Description | Units | Units |
| Volume of Air (V₁) | 5.88 gallons | 0.022 m³ |
| Volume of Water (V_{WATER}) | 74.12 gallons | 0.281 m³ |
| Available energy of air (E_{AIR}) | — | 51.65 kJ |
| Available energy of water (E_{WATER}) | — | 0.107 kJ |
| Total available energy (E_{AIR} + E_{WATER}) | — | 51.76 kJ |

In the elevated pressure condition described in Table 3, 51.76 kJ of energy could be released to atmosphere in the event of a structural failure of the fluid vessel. 99.8% of this total released energy would be from the stored compressed air. Because the compressed air can rapidly expand, the resulting energy release may be explosive.

Assume now that the same hypothetical fluid vessel is fitted with a pressure relief apparatus 180 as shown and described herein (“the modified fluid vessel” for purposes of this prophetic Example). Assume further that the pressure relief apparatus 180 is set to release compressible fluid upon exceeding a first pressure of 100 psi (689,475 Pa).

Because the typical pressure of 90 psi (620,528 Pa) is lower than the threshold pressure, the volume and energy conditions in the modified fluid vessel would be identical to those shown in Table 2 above.

However, when the water in the modified fluid vessel is increased to the elevated pressure of 200 psi (1,378,951 Pa) from Table 1, the pressure relief apparatus 180 is activated to release air from the modified fluid vessel. If the elevated pressure is sustained, or if it repeats sufficiently, all of the air will be forced from the modified fluid vessel. In this condition, the volumes and energy stored in the modified fluid vessel are as follows:

TABLE 4
Energy Stored in Modified Fluid Vessel
at Elevated Pressure

| | English/Common | SI |
|---|---|---|
| Description | Units | Units |
| Volume of Air (V₁) | 0 gallons | 0 m³ |
| Volume of Water (V_{WATER}) | 80 gallons | 0.302 m³ |
| Available energy of air (E_{AIR}) | — | 0 kJ |
| Available energy of water (E_{WATER}) | — | 0.116 kJ |
| Total available energy (E_{AIR} + E_{WATER}) | — | 0.116 kJ |

It can be seen from Table 4 above that the modified fluid vessel now stores only 0.116 kJ as compared with 51.76 kJ stored in the fluid vessel of Table 3. In other words, even though both fluid vessels are the same size and the pressure in both is 200 psi (1,378,951 Pa), the modified fluid vessel stores about 99.8% less energy. Moreover, because the energy stored in the modified fluid vessel is stored in an incompressible fluid (water), release of such energy will not result in rapid expansion.

As will be understood by one skilled in the art, the present disclosure is not limited by the embodiments described in the prophetic Example. Furthermore, while air and water are used herein as compressible and incompressible fluids to illustrate certain benefits of the present disclosure, it should be understood that equivalent or similar benefits are realizable using other compressible and incompressible fluids.

### End of Prophetic Example

FIG. 2A is a schematic view of another exemplary hydropneumatic system 10 according to the present disclosure. The embodiment depicted in FIG. 2A is similar to the embodiment shown in FIG. 1A, except that the flexible barrier 110 comprises an expandable bladder rather than a diaphragm. An expandable bladder may be chosen if future replacement of the flexible barrier 110 may be desirable or necessary. In such systems, a service opening may be provided at the top of the fluid vessel 100 to allow the expandable bladder to be removed and replaced. In typical diaphragm systems, as shown in FIGS. 1A-1D, the diaphragm is not replaceable, and a new fluid vessel 100 must be purchased upon diaphragm failure.

FIG. 2B is a schematic view of an exemplary hydropneumatic system 10 as in FIG. 2A. The view in FIG. 2B corresponds to the view in FIG. 1B, except that the flexible barrier 110 comprises an expandable bladder rather than a diaphragm.

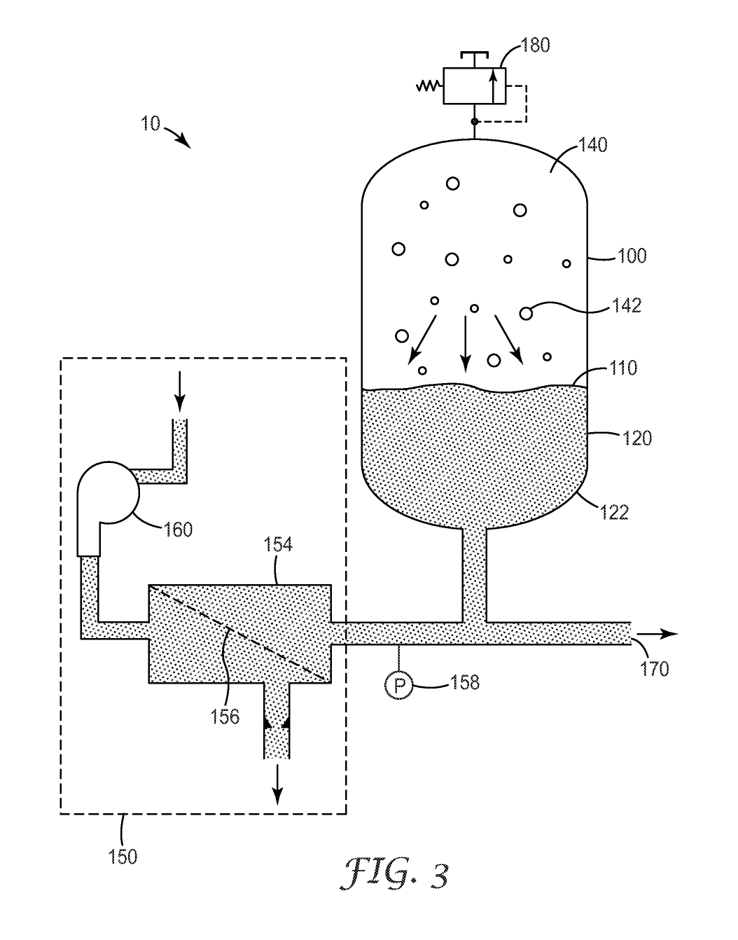

Moving on to FIG. 3, a hydropneumatic system 10 as depicted and described in FIGS. 1A-1D is shown wherein the incompressible fluid source 150 comprises a filtration system 154. As shown, the filtration system 154 comprises a reverse osmosis filtration element. The reverse osmosis system shown in FIG. 3 is a typical one wherein a fluid pump 160 is disposed upstream to act as a booster pump to supply feed water to the reverse osmosis filtration element. The water that passes through the reverse osmosis filtration element (the permeate water) is supplied to the hydropneumatic system 10. Concentrate or brine water is routed through a flow restrictor to drain.

In some such systems, a pressure control device 158 is provided in fluid communication with the incompressible fluid 122. The pressure control device 158 can monitor the second pressure and provide feedback to the fluid pump 160 to control the second pressure to an operating pressure. This feedback, often provided through a microcontroller, mechanical pressure switch, or the like, can call on the fluid pump 160 to supply more incompressible fluid 122 when the second pressure drops below the operating pressure.

In many reverse osmosis systems, the reverse osmosis filtration element generates a relatively high pressure drop and a corresponding low fluid flow rate. Thus, water often cannot be forced across the reverse osmosis filtration element at a sufficient volumetric flow rate to meet sustained downstream demand at the incompressible fluid outlet 170. In such cases, a hydropneumatic system 10 as shown in FIG. 3 may be useful to provide increased fluid capacity and driving force. However, as discussed above, if over-pressure conditions cause the release of some or all of the compressible fluid 142 (through the pressure relief apparatus 180) from the fluid vessel 100, performance at the incompressible fluid outlet 170 will diminish and eventually return to the relatively poor performance of a non-hydropneumatic system. Such a state may occur, for example, if the pressure control device 158 malfunctions or otherwise ceases to provide proper feedback to the fluid pump 160, thus allowing the second pressure to rise above the operating pressure and eventually cause the first pressure to exceed a threshold pressure of the pressure relief apparatus 180.

This controlled release of compressible fluid 142 can provide the benefits described above, namely mitigating over-pressure conditions, alerting the end user to over-pressure conditions by reducing system flow performance, and reducing the potential energy stored in the fluid vessel 100 to decrease the severity of a structural failure of the fluid vessel 100.

While the filtration system 154 shown comprises a reverse osmosis filtration element, it should be understood that benefits described herein are achievable using other types of filtration systems. For example, it is envisioned that the filtration system 154 may comprise one or more carbon blocks, sediment filters, ion-exchange filters, or the like in embodiments according to the present disclosure.

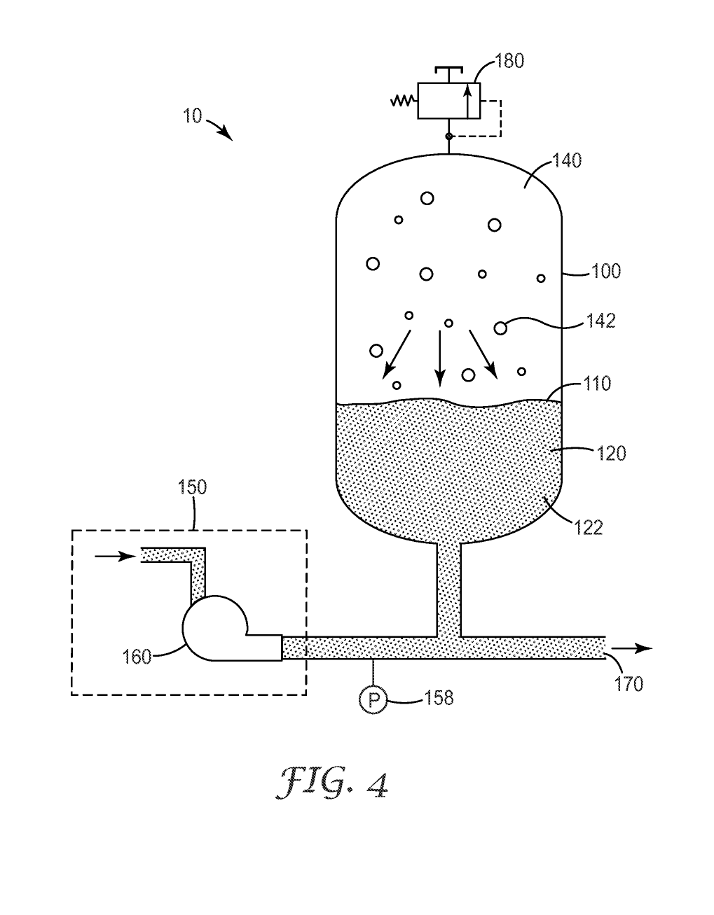

FIG. 4 is a schematic view of an exemplary hydropneumatic system 10 as depicted and described in FIGS. 1A-1D wherein the incompressible fluid source 150 comprises a fluid pump 160. In one such embodiment, a pressure control device 158 monitors the second pressure and provides feedback to the fluid pump 160 to control the second pressure to an operating pressure.

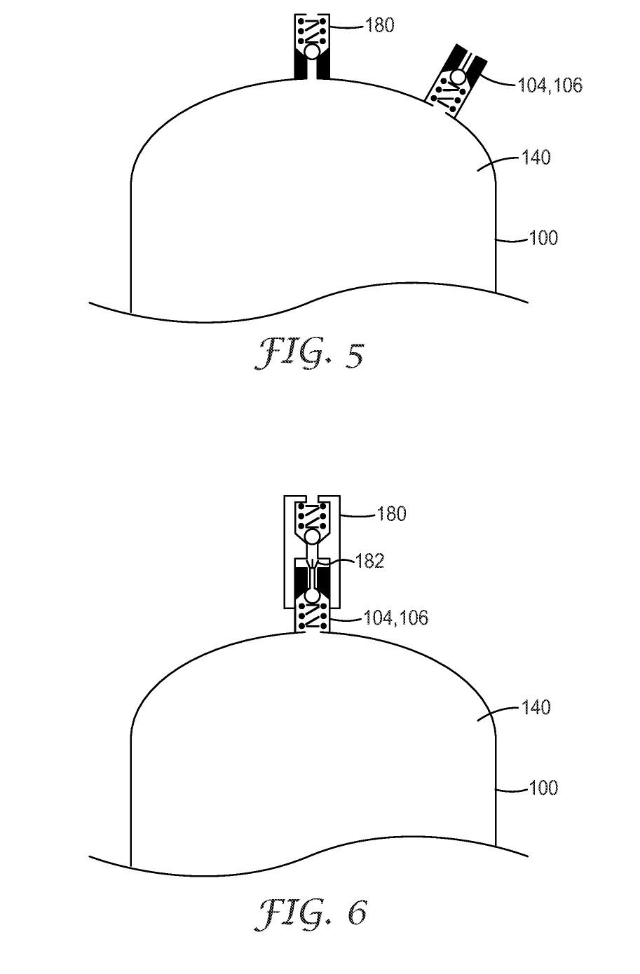

Referring now to FIG. 5, a partial detailed schematic view of an exemplary hydropneumatic system 10 is shown wherein the fluid vessel 100 comprises a first compressible fluid charging port 104 and a pressure relief apparatus 180. The first compressible fluid charging port 104 is typically used to charge, or fill, the compressible fluid portion 140 with a compressible fluid 142. In some cases, the compressible fluid 142 is pre-charged to an initial pressure before the fluid vessel 100 is put into use. For example, before the fluid vessel 100 is shipped to the end user, the first compressible fluid charging port 104 may be used to pre-charge the compressible fluid portion 140 with a compressible fluid 142 at 1 psi (6,894 Pa), 5 psi (34,473 Pa), 7 psi (48,263 Pa), 10 psi (68,947 Pa), 15 psi (103,421 Pa), 20 psi (137,895 Pa), 30 psi (206,843 Pa), 35 psi (241,317 Pa), 45 psi (310,264 Pa), 55 psi (379,212 Pa), or even 65 psi (448,159 Pa), including all values within that range. The compressible fluid 142 may be any suitable compressible fluid 142, but is commonly air or nitrogen. In certain cases, nitrogen may have a lesser tendency to permeate through the flexible barrier 110.

In one embodiment, the first compressible fluid charging port 104 comprises a first spring-assisted poppet valve. Typically, the first spring assisted poppet valve comprises a one-way valve (or check valve) allowing a compressible fluid 142 to be injected into the compressible fluid portion 140, but not released therefrom unless the poppet is physically forced open by the user or a tool. In one embodiment, the first spring-assisted poppet valve comprises a Schrader valve. In a typical Schrader valve, a centrally-disposed valve core comprises a plunger that must be depressed to allow fluid to pass through the valve. Thus, in order to inject into or release compressible fluid 142 from the compressible fluid portion 140, either the plunger must first be depressed or the entire valve core must be removed. The first fluid charging port may alternatively comprise other commonly known pneumatic valves such as a Presta valve.

FIG. 5 also depicts an exemplary pressure relief apparatus 180 in fluid communication with the compressible fluid portion 140. In one embodiment, the pressure relief apparatus 180 comprises a one-way valve (or check valve) allowing a compressible fluid 142 to be released from the compressible fluid portion 140 when a first pressure of the compressible fluid 142 exceeds a threshold pressure.

FIG. 6 depicts an exemplary hydropneumatic system 10 according to the present disclosure wherein the fluid vessel 100 comprises a first compressible fluid charging port 104 and a pressure relief apparatus 180 connected to the first compressible fluid charging port 104. In some embodiments, the first compressible fluid charging port 104 comprises a threaded surface to allow threadable connection of a pressure relief apparatus 180. As shown, the first compressible fluid charging port 104 comprises a first spring-assisted poppet valve comprising a depressible plunger. The pressure relief apparatus 180 comprises a valve-depressing member that can depress the plunger of the first spring-assisted poppet valve, thus allowing the compressible fluid 142 in the compressible fluid portion 140 to access the pressure relief apparatus 180. In one embodiment, the first spring-assisted poppet valve comprises a Schrader valve and the pressure relief apparatus 180 comprises a valve depressing member to depress the Schrader valve plunger.

Alternatively, the valve core of the Schrader valve may be removed and a pressure relief apparatus 180 with no valve-depressing member may be connected to the Schrader valve. On example of a pressure relief apparatus 180 that is designed to connect to a Schrader valve with the valve core removed is the model 4110 pressure relief valve available from GENUINE INNOVATIONS, Tuscon, Ariz. However, in an embodiment as sown in FIG. 5, it is typically not desirable to remove the valve core because the process of removing the valve core will let all or a portion of the compressible fluid 142 out of the compressible fluid portion 140. Then, because a pressure relief apparatus 180 covers the first compressible fluid charging port 104, there is no way to inject more compressible fluid 142 into the compressible fluid portion 140. Thus, products such as the model 4110 may not be desirable in such applications.

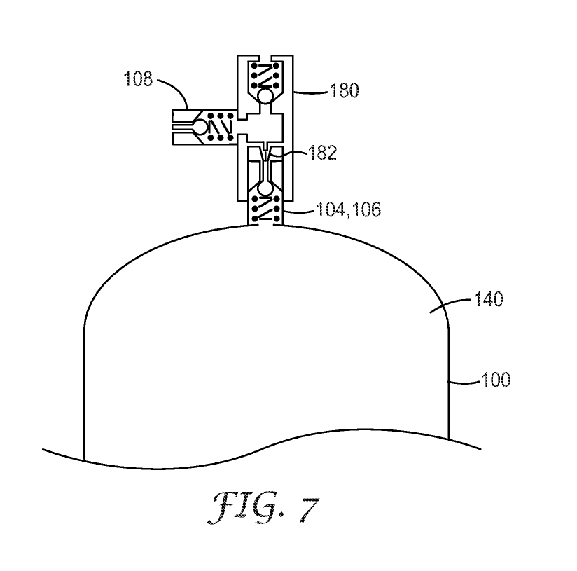

Yet another embodiment is shown in FIG. 7. FIG. 7 is a partial detailed schematic view of an exemplary hydropneumatic system 10 according to the present disclosure wherein the fluid vessel 100 comprises a first compressible fluid charging port 104 and a pressure relief apparatus 180, wherein a second compressible fluid charging port 108 connected to the first compressible fluid charging port 104. In such an embodiment, the user may choose to leave the valve core of the first compressible fluid charging port 104 intact and provide the pressure relief apparatus 180 with a valve depressing member to allow the compressible fluid portion 140 to be in fluid communication with the pressure relief apparatus 180. Alternatively, the user may remove the valve core from the first compressible fluid charging port 104 because a second compressible fluid charging port 108 is provided to charge or recharge the compressible fluid portion 140. In embodiments as shown in FIG. 7, the user can beneficially retain a functional pressure relief apparatus 180 and maintain access to charge the compressible fluid portion 140 at the same time.

Various modifications and alterations of the invention will be apparent to those skilled in the art without departing from the spirit and scope of the invention. It should be understood that the invention is not limited to illustrative embodiments set forth herein.

1. A hydropneumatic system comprising:
a fluid vessel comprising:
an incompressible fluid portion; and
a compressible fluid portion to contain a compressible fluid at a first pressure, the compressible fluid portion being in pressure communication with the incompressible fluid portion and separated from the incompressible fluid portion by a flexible barrier;
an incompressible fluid source to supply an incompressible fluid at a second pressure to the incompressible fluid portion, the first pressure being in substantial equilibrium with the second pressure;
an incompressible fluid outlet in fluid communication with the incompressible fluid portion; and
a pressure relief apparatus in fluid communication with the compressible fluid portion to release at least a portion of the compressible fluid from the fluid vessel when the first pressure exceeds a threshold pressure.

2. The hydropneumatic system of claim 1 wherein the flexible barrier comprises an expandable bladder.

3. The hydropneumatic system of claim 1 wherein the flexible barrier comprises a diaphragm.

4. The hydropneumatic system of claim 1 wherein the incompressible fluid source comprises a filtration system.

5. The hydropneumatic system of claim 4 wherein the filtration system comprises a reverse osmosis filtration element.

6. The hydropneumatic system of claim 1wherein the incompressible fluid source comprises a fluid pump.

7. The hydropneumatic system of claim 6 wherein the fluid pump comprises a well pump.

8. The hydropneumatic system of claim 1 further comprising a first compressible fluid charging port in fluid communication with the compressible fluid portion.

9. The hydropneumatic system of claim 8 wherein the pressure relief apparatus is connected to the first compressible fluid charging port.

10. The hydropneumatic system of claim 9 wherein the pressure relief apparatus is threadably connected to the first compressible fluid charging port.

11. The hydropneumatic system of claim 10 wherein the first compressible fluid charging port comprises a first spring-assisted poppet valve.

12. The hydropneumatic system of claim 11 wherein the pressure relief apparatus comprises a valve-depressing member to depress the first spring-assisted poppet valve.

13. The hydropneumatic system of claim 9 further comprising a second compressible fluid charging port in fluid communication with the compressible fluid portion and accessible while the pressure relief apparatus is connected to the first compressible fluid charging port.

14. The hydropneumatic system of claim 1 wherein the incompressible fluid source comprises a pressure control device to control the second pressure to an operating pressure, wherein the operating pressure is lower than or equal to the threshold pressure.

15. A method of limiting the potential energy stored in a fluid vessel comprising:
supplying an incompressible fluid at a second pressure to an incompressible fluid portion of the fluid vessel, the fluid vessel comprising a compressible fluid portion comprising a compressible fluid at a first pressure, the compressible fluid portion being in pressure communication with the incompressible fluid portion and separated from the incompressible fluid portion by a flexible barrier such that the first pressure is in substantial equilibrium with the second pressure;
supplying the incompressible fluid to an incompressible fluid outlet; and
releasing at least a portion of the compressible fluid from the fluid vessel when the first pressure exceeds a threshold pressure.

16. The method of claim 15 wherein the compressible fluid portion is separated from the incompressible fluid portion by an expandable bladder.

17. The method of claim 15 wherein the compressible fluid portion is separated from the incompressible fluid portion by an elastomeric barrier.

18. The method of claim 15 further comprising:
releasing a sufficient amount of the compressible fluid from the fluid vessel to cause the compressible fluid portion to cease assisting in the supply of incompressible fluid to the incompressible fluid outlet.

19. The method of claim 15 further comprising:
controlling the second pressure to an operating pressure, wherein the operating pressure is lower than or equal to the threshold pressure.
